(19) United States
(12) Patent Application Publication
(10) Pub. No.: US 2004/0099614 A1
(43) Pub. Date: May 27, 2004

(54) Method and device for the physicochemical treatment of fluid media

(76) Inventors: Jorg Lehmann, Kesselsdorf (DE); Hans-Peter Stacker, Bunde (DE)

Correspondence Address: GUDRUN E. HUCKETT, LONSSTR. 53, WUPPERTAL, 42289, DE

(21) Appl. No.: 10/276,397

(22) PCT Filed: May 14, 2001
(86) PCT No.: PCT/DE01/01868

(30) Foreign Application Priority Data
May 14, 2000 (DE) 100249027
May 14, 2000 (DE) 100249019

(51) Int. Cl. C02F 1/38

(52) U.S. Cl. 210/787; 210/774; 210/182; 210/512.1; 210/143; 210/748; 95/260; 95/261; 96/205; 96/216

(57) ABSTRACT

The invention relates to a method and a device for the physicochemical treatment of fluid media. The aim of the method is to modify the surface tension and the viscosity of the fluid, to mechanically reduce and eliminate organic and/or inorganic substances, micro-organisms, such as for example microbes, bacteria, fungi or algae and to chemically oxidise or reduce substances and material compounds entrained by the fluids. According to said method, energy is supplied to the fluid that is to be treated as follows: at least two volumetric flows of the fluid are guided at high speed, so that their surfaces intermingle or collide with one another in the form of a translational and/or rotational motion at a different speed, if the flows originate from the same direction, or at a selectable speed, or optionally an identical speed, if the flows originate from opposite directions. The flows are guided in such a way that considerable friction is produced between the two layers of flow, in addition to extreme centrifugal forces in the individual volumetric flows. The inventive device carries out the inventive method in a manner which is rapid, cost-effective, space-saving and environmentally friendly.

The invention relates to a method and a device for physicochemical treatment of fluid media. In the context of this teaching, fluid media or fluids are gaseous and liquid materials and mixtures of gaseous or/and liquid materials.

The method according to the invention causes in the fluid to be treated changes of the surface tension and of the viscosity of the fluid, mechanical comminution and destruction of organic or/and inorganic substances, microorganisms, for example, germs, bacteria, fungi or algae, contained in the fluid, and chemical oxidation or reduction of entrained materials and compounds.

The device according to the invention carries out the method according to the invention quickly, inexpensively, in a space-saving way, and environmentally friendly.

Fluids, for example, water or fuels, that are treated according to the method of the invention and by means of the device according to the invention can be used in all areas of daily life. Most important fields of application are industry, trades, residential uses, food industry, agriculture and forestry, refuse and sanitation industry, cleaning technologies, degermination, preservation, machine construction, electronics, the medical field and therapy, construction industry, and energy technology.

In the past, changes of the surface tension or viscosity in fluids have been achieved in that, for example, in the case of water, either corresponding chemical substances have been added or in that a reduction was caused by means of physical methods, such as treatment by permanent magnets or solenoids, by which the fluid is moved. For example, applications for surface tension-reduced water include wash liquors for cleaning, uses in the construction industry and concrete manufacture, the mining industry or oil production, pressing in porous rock layers, heat transfer systems or cooling systems. The exclusive use of chemical substances necessitates in many processes in industry an after treatment of the parts that come into contact with this water or liquor, in particular, an extensive flushing, wherein again large quantities of water resources are spent. Moreover, the disposal of the resulting wastewater is complex and time-consuming.

Physical systems moreover have a natural limit for the reduction of surface tension, for example, in the case of water the limit is 8-12%. Moreover, the water which is treated in this way can be stored only to a limited extent because after a relatively short amount of time it returns to its initial state.

In the past, foreign materials in inorganic or organic form up to a certain size have been separated from fluids by filtration. Other methods provide for chemical reactions by addition of chemical or biological reaction components so that the resulting waste products are precipitated and removed mechanically from the fluid. Other methods destroy with high energy expenditure, for example, by ultrasound, the structures that are present and comminute them up to a certain efficiency. All of these methods have the problem that, in addition to the energy consumption, a relatively high apparatus-related technical expenditure is required and that in most cases several processing steps must be performed for achieving the desired results. The maintenance, control, and operation of such devices is time-consuming and cost-intensive.

In the past, the cleaning of chemical or biologically loaded water has been performed by complex, usually multi-step, processes. Chemical biological processes of wastewater treatment are used but also purely chemical methods such as, for example, the addition of bacteriocides to biologically loaded water for industrial use or service water. Other methods use the energy introduction by UV rays or the addition of precipitating agents for removal of primarily chemical or biological loads. All methods have the problem that they are cost-intensive and require a high technical expenditure and generate waste products that must be disposed of.

Devices for mechanical cleaning of liquids or gasses are known, for example, from AT 272 278 and DE 195 25 920. The basis of these devices is the utilization of a reaction chamber into which water or exhaust gases are blown tangentially so that they move in rotation to the lower end of the chamber, wherein, by means of openings at the lower apex of the device, reaction components are added and the reaction components then leave the chamber via an outlet pipe at the lower end of the reaction chamber in a direction counter to the previous flow direction.

According to the disclosure of these patent documents, water, for example, is introduced into the chamber. Along the chamber wall a moving vortex is generated which has a downwardly oriented tip. At the lower apex, this vortex is mixed with a reaction agent via one or several coaxially arranged nozzles and moves as a result of this as a spiral on the inner side in the opposite direction into an elongate outlet pipe and, in this pipe, moves in cycloid movements upwardly. According to AT 272 278 and DE 195 25 920, water in cycloid movements under certain conditions can have the capability of enabling syntheses of different kinds. The reactions according to AT 272 278 begin at the lower apex and continue in the outlet pipe under cycloid movements. For the reaction, it is advantageous according to AT 272 278 that by means of an “. . . inner central suction vortex secondary air for the reaction is taken in”.

Such vortex formations are known inter alia also in cyclones or centrifuges and enhance minimally chemical reactions in the medium.

In DE 195 25 920 a supplement of the device of AT 272 278 is described in which the medium to be cleaned flows, while alternatingly rising and falling, through interconnected supply pipes and subsequently is guided, after leaving the chamber, into a pipe labyrinth for sedimentation or for catching the compressed waste products.

Disadvantages of these devices are the complex configuration, difficult handling for a targeted technical application, the unsatisfactory adjustability and the resulting lack of reproducibility of the results.

The object of the invention resides in providing an environmentally friendly method for physicochemical treatment of fluid media for decomposition of organic and inorganic ingredients of fluid media, for killing microorganisms such as bacteria, fungi, germs, algae etc., comminution of long-chain molecular components and decomposition by means of chemical reactions, changes of the viscosity or/and of the surface tension of fluids, and a device for performing the method.

According to the invention, this object is solved in that energy is supplied to the fluid to be treated in that at least two volume flows of the fluid are guided at high speed, in the case of identical direction of the flows, in the form of translational or/and rotational movement with different speed or, in the case of opposite flow direction, respectively, with freely selectable or optionally identical speed within one another or on one another with areal contact such that a high friction between the two layers as well as high centrifugal forces are created in the individual volume flows. Further configurations of the method according to the invention are disclosed in the features of the dependent claims 2 through 10.

The guiding of the volume flows is realized preferably as a forced guiding action in a pipe system or container system such that at the same time rotational and translational movements of the volume flows are possible. The volume flows can originate from different sources or can be produced by dividing a volume flow into two partial volume flows. The partial volume flows can be generated alternatively also by deflection of a volume flow so that the physicochemical processes occur between two sections of the same volume flow.

The speed of the volume flows is to be selected such that flow-technologically a turbulent boundary layer can be formed and the volume flows have a high speed differential relative to one another.

The volume flows are generated such that as a result of the flow speed only in the turbulent boundary layer swirling and mixing between the two boundary layers can occur. The individual volume flows themselves can be present, starting at the boundary layer, as a laminar flow or a turbulent flow.

Preferably, a combination of translational movement and simultaneous rotational movement is selected such that the volume flows contact one another in opposite direction or such that a volume flow is deflected such that the portion moving in the direction of the outlet has a movement direction counter to the direction of the supply.

The selection of the speed of the volume flow depends on the medium to be treated and, depending on the primary purpose of the treatment, can be determined based on the strength of the secondary valence bond or stability of the molecules. The centrifugal force or/and the translational force are to be selected such that breaking of at least some of the secondary valence bonds occurs, that a breaking up of the compounds and molecule chains of the foreign materials occurs, and that they are mechanically destroyed or comminuted or/and the foreign materials that are present or the atoms, the molecules or molecular compounds of the fluid medium are at least partially ionized or radicalized.

The high kinetic energy, the energy introduction caused by the friction of both volume flows on and within one another, the resulting high centrifugal force or/and translational force as well as the frictional force effect, by breaking up and newly forming the present secondary valence bonds as a result of their different atomic mass and thus the different mass inertia as well as by collision of the individual particles, atoms, and atom groups as well as molecules with one another, a new orientation of the molecule or microstructure to an energetically stable and equilibrated, optimal state and interconnection and thus a change of the normally present surface tension or/and the viscosity.

These changes can be adjusted by changing the speeds depending on the medium that is present. By means of the achieved new orientation of the molecular structure, gases or volatile foreign materials dissolved in the fluid are released so that additionally a degassing action takes place. By means of this degassing action, undesirable reactions of these entrained materials within the medium to be treated itself, with other entrained materials or with materials which come into contact with the fluid, such as measuring sensors or pipe walls, can be additionally reduced or prevented.

When selecting the flow speed, a material separation can be achieved in each individual volume flow as a result of different densities of the materials contained in the fluid medium, which separation is reinforced for translational and rotational movement.

The fluid or fluid mixture treated according to the present intention maintains its state of decreased surface tension or the changed viscosity over an extended period of time. Entrained materials are removed from the microstructure of the fluid medium or/and are separated by means of centrifugal force as a result of the different specific densities of the medium and can subsequently be sedimented.

The high kinetic energy, the energy introduction caused by the friction of both volume flows on and within one another, the resulting high centrifugal force or/and translational force as well as the frictional force effect in the foreign material by collision of the organic or/and inorganic materials, compounds, plant or/and organic creatures, for example, germs, bacteria, fungi or algae, with one another and with the individual particles, atoms and atom groups as well as molecules of the fluid medium a mechanical destruction and comminution of these foreign materials.

Moreover, organic substances, materials, or compounds, plant or other organic creatures are destroyed because of their own mass inertia as a result of the different relative density and the high translational or/and centrifugal force.

The quantity and the quality of this mechanical destruction and comminution can be adjusted by changing the speeds depending on the fluid or foreign materials that are present. It depends on the resistance against mechanical load of the foreign materials.

The foreign materials destroyed in this way can be subsequently filtered, sedimented, or can be bound in other ways.

The high kinetic energy, the energy introduction caused by the friction of both volume flows on and within one another, the resulting high centrifugal force or/and translational force as well as the frictional force effect by collision of smallest particles, such as a particles or electrons, with the atoms, molecules or/and molecular compounds of the fluid or/and of the foreign medium an attachment or loss of electrons on them and thus a negative (anion) or positive (cation) charge of these materials. Moreover, the formation of radicals can be carried out by cleavage of molecules or/and attachment of atoms or molecules.

The resulting ions or radicals are products having a high chemical affinity and react immediately, for obtaining a stable atomic energy state, with other available atoms, molecules or molecular compounds of the fluid, of the entrained or added foreign materials, or with one another by formation of corresponding oxidation or reduction products.

By means of entrained or/and added oxidation agents such as ozone or oxygen, hydrocarbon compounds or/and otherorganic substances such as germs, bacteria, and small creatures can be oxidized. This causes inter alia the formation of H₂O and CO₂, i.e., in the case of organic substances denaturization occurs.

For performing the method, according to the invention a device is selected which has at least one inlet and an outlet as well as the possibility of a targeted metering of additives which can be gaseous or a liquid or a solid, and wherein the length of the contact stretch of the two volume flows prevents a complete mixing based on the resulting frictional resistance of the volume flows and the caused energy loss. The device is designed such that the flow resistance can be adjusted by adjusting possibilities on the inlet, the additive medium, and on the device itself.

In a preferred embodiment of the invention, a device for physicochemical treatment of fluid media is a fluid reactor device with the features according to claim 10. Advantageous configurations of the invention are disclosed in the features of claims 11 to 27.

The fluid reactor device is comprised of a housing having a rotationally symmetrical cavity (reaction chamber) which is heart-shaped in longitudinal-section, one or several inlets connected with the reaction chamber and an outlet for the medium to be treated, an inlet for an additive medium and peripheral components such as hoses or pipes for media transport, valves, flow dividers, pre-treatment units.

A rotationally symmetrical cavity is provided in the housing with at least one media inlet and at least one media outlet pipe. The cavity and the inlet or outlet openings are designed and arranged relative to one another such that in the fluid to be treated upon passing through the cavity from the inlet opening to the outlet opening a shearing strain as large as possible is generated which is caused by the friction of the individual flow layers relative to one another and with the wall of the cavity.

The housing is provided laterally in the upper area with at least one media inlet having an inlet opening that opens into the cavity. Expediently, the media inlet or media inlets are arranged such that the fluid to be treated in the cross-section of the inlet opening enters the cavity tangentially to the peripheral surface of the cavity and with descending inflow direction.

In the upper area of the cavity the housing is also provided with a centrally arranged outlet passage which is guided through the wall of the housing preferably in the direction of the longitudinal axis of the cavity and, in this way, coincides with it.

Through this outlet passage, an outlet pipe is introduced into the cavity and extends approximately to the lower end wherein the outlet pipe is supported slidably in the outlet passage so that the spacing between the opening of the outlet pipe and the lower end of the cavity can be adjusted.

In an advantageous configuration of the invention, the outlet pipe is embodied as a Laval nozzle in the area of its opening.

The contour of the cavity is similar in cross-section to that of a heart.

In the lower part of the housing in the mounted position an inlet with one or several openings that open into the cavity is provided for a second medium and is arranged centrally. Its outlet is expediently in the form of a pipe-shaped extension of the housing material into the interior of the cavity. The pipe-shaped extension is formed constructively by a pin projecting as a result of the contour reversal of the cavity from the bottom of the cavity. It is provided for the purpose of supplying a second medium via one or several bores extending parallel to the imaginary longitudinal axis of the cavity.

For optimizing the pressure and flow conditions in the reaction chamber, the inlet for the additive medium can be embodied, in analogy to the outlet pipe, as a separate component which, relative to the reactor housing, is slidably guided in the direction of the imaginary longitudinal axis of the cavity.

The function of the device according to the invention resides essentially in the initialization of chemical reactions by providing suitable pressure conditions upstream of the outlet pipe, in the centrifugal and centripetal forces acting on the flowing medium differently on the different components contained therein, and in the frictional forces caused between the flow layers of different speeds. The constructive configuration of the invention is selected such that a speed with a maximum value as high as possible and a gradient as high as possible in the radial direction is imparted onto the medium when flowing through the reaction chamber at the defined pressure.

These conditions are fulfilled with the device according to the invention in that in the medium to be treated a cyclone is generated and, when passing through the cyclone, a speed is imparted on the volume flow which depends on the radius and which increases over all in the longitudinal direction.

The flow conditions required for generating a centrifugal effect as large as possible and shearing strain as large as possible in the fluid to be treated are obtained by the constructive configuration of the reactor. By means of the contour of the cavity of the reactor the volume flow of the medium to be treated is deflected such that in the descending branch of the flow course (i.e., between the inlet of the medium and the opening of the outlet of the medium) a cyclone is formed. The flow speed in the cyclone has a large gradient in the radial direction across its cross-section. In this way, shearing strain between the individual flow layers relative to one another but also between the wall of the reaction chamber and the medium to be treated are generated.

The frictional forces within the volume flow, which are generated by the shearing strain and act in the opposite direction relative to the shearing strain, result because of the new orientation of the bonds between the molecules of the medium to be treated in a lowering of the surface tension strain and a change of the viscosity of the fluid.

Moreover, a grinding effect is obtained. The high speed differential between the volume flow in the wall of the reaction chamber results in a comminution of solid components such as, for example, bacteria, algae, and other microorganisms. Subsequently, the resulting debris is then chemically decomposed.

Moreover, the cross-section of the reaction chamber tapers in the direction from the media inlet toward the media outlet such that the cyclone flow is greatly accelerated. The thus resulting kinetic energy of the elementary particles of the medium results in an increase of reactivity.

At the lower end of the reaction chamber, the flow which flows in a descending helical line, becomes the center of the flow and is deflected there in an ascending direction. In this area, a great centrifugal action takes place because the inorganic or/and organic contaminants entrained as suspended particles as a result of their higher density are then driven away from the center of the cyclone to its edge while dissolved gaseous components as a result of their minimal density are driven from the edge of the cyclone to its center.

During the occurring directional change of the volume flow in the lower part of the reaction chamber, the already separated contaminants and media of different densities are moved again in the opposite direction across the cross-section of the volume flow.

When these highly reactive components of the medium to be treated impact on one another, chemical reactions occur, for example, a cold oxidation, as a result of which contaminants are decomposed.

The strength of the described effects and therefore the efficacy of the device according to the invention depends on pressure, speed, and temperature. The heart-shaped inner contour of the reaction chamber effects in the formed cyclone such a strong acceleration of the volume flow that the biological, physical, and chemical processes occurring within the medium are also accelerated. Extensive experiments with different inner contours and adjustments of the process parameters have shown that, when using a heart-shaped inner contour in combination with the adjustment of media-specific changeable parameters, such as volume flow, flow pressure, and dynamic pressure of the medium to be treated, the type and quantity of the additive medium, the contour of the Laval nozzle, and the position of the additive media inlet and of the medium outlet relative to one another, and the medium temperature, optimal results are obtained.

As a result of the configuration of the outlet pipe in the area near the opening as a Laval nozzle in combination with the supply of the volume flow into the reaction chamber, the medium is accelerated greatly and relieved in the outlet pipe wherein in the case of liquids the vapor pressure can be reached or under-run in the core area and a flow results that has greatly differing speeds in the core area and the edge area. With minimal flow speeds a hollow vortex results in whose center a core of a lighter fluid is formed in comparison to the remaining flow field. With increasing speeds, vortex flows with vortex threads or a vortex tube are formed or, depending on the type of medium, a rotation-free vortex with vortex core, also referred to as streamline vortex, is generated. In this connection, shearing strains in the flowing medium are achieved which further enhance the physical and chemical processes.

Special advantages of the device according to the invention reside in that with minimal space expenditure and cost expenditure without adding environmentally harmful chemicals and without radiation of the medium or other potentially harmful measures an effective, an inexpensive process can be performed which provides, depending on the application, decontaminated or degermed waste water to be used again, water reservoirs can be kept free of germs; in areas where water is scarce, a supply with fresh water can be ensured; the wettability of different liquids can be increased; the use of detergent chemicals for different cleaning purposes in residential and industrial applications can be significantly reduced; and, in this way, the environmental load can be reduced, or thick viscous media can be thinned without chemical changes in a purely mechanical way.

The aforementioned applications are only a few examples of the versatility and environmentally friendly uses of the device according to the invention.

For obtaining optimal results, observing some process parameters, such as flow pressure of the medium to be treated, speed profile of the cyclone and dynamic pressure in the reaction chamber, addition of reaction partners having affinity in their required concentration depending on the application purpose, is mandatory. For this purpose, with the device according to the invention for the first time the required conditions are provided.

With the geometric configuration of the reaction chamber the required high and strong gradient-affected speeds in the medium are generated. They are required for obtaining the physical effects, i.e., comminution of solid particles and the new orientation of molecular bonds, and initiating and accelerating the chemical processes by supplying energy.

The use of pumps or/and compressors generates the required dynamic pressure in combination with the adjustability of the media outlet pipe as well as the ratio of the inlet diameter and the diameter of the media outlet pipes.

The metered introduction of the oxidation agent or other additive media serving as reaction partners not only into the media outlet pipe but also into the main inlet, i.e., upstream of where the medium to be treated enters the reaction chamber, ensures a significant increase of the reaction rate. The reaction rate can be even more increased by a catalytically acting coating of the parts for guiding the media of the device or/and changes of the temperature.

The described processes can be preformed particularly effectively when a process control or governing device is used which, based on measured process-relevant characteristic values, can adjust the aforementioned parameters continuously to the momentary requirements.

With the aid of the drawings, the invention will be explained in more detail. It is shown in:

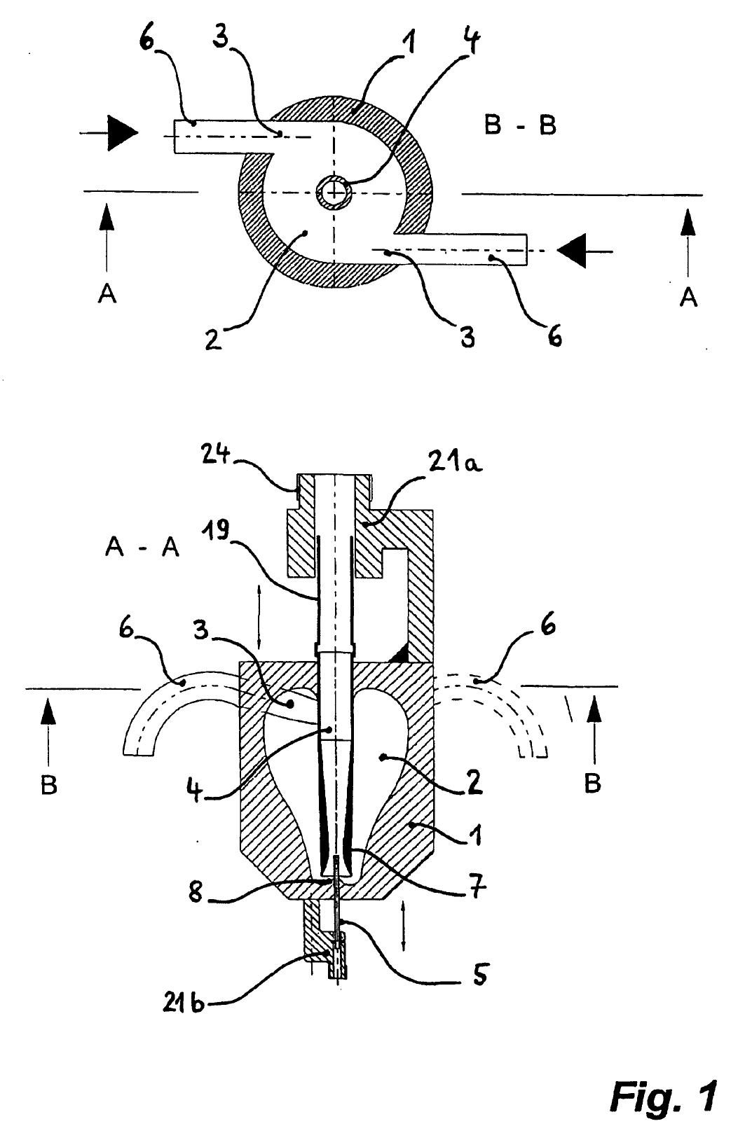

FIG. 1 the reaction chamber

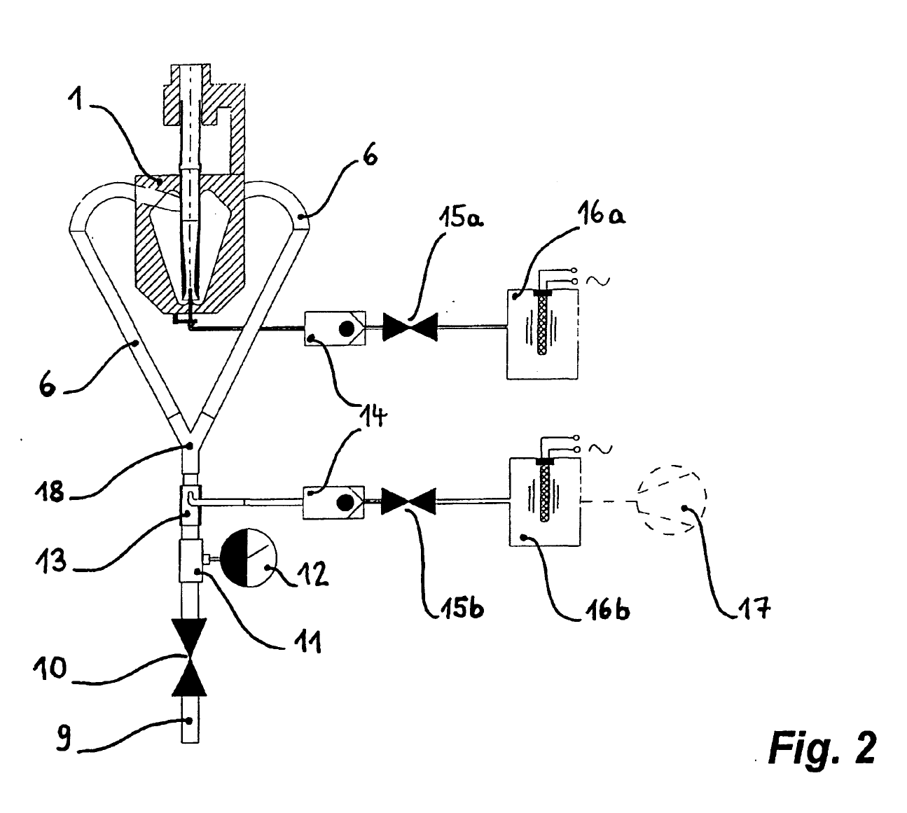

FIG. 2 the fluid reactor device

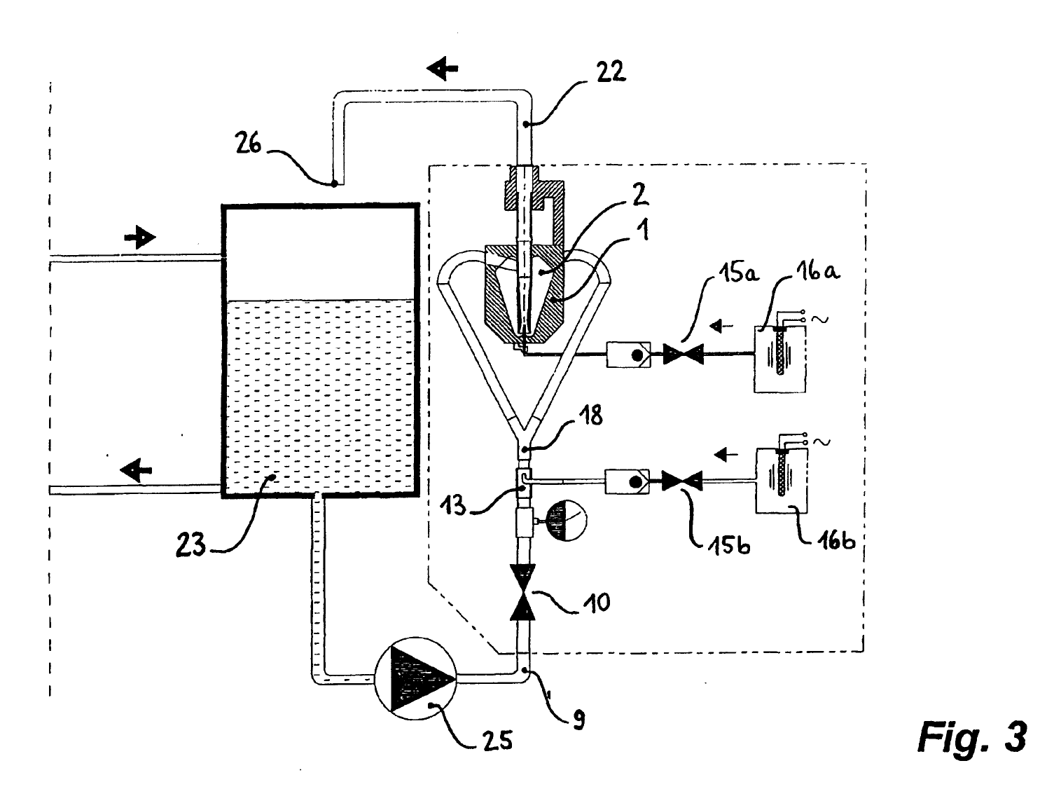

FIG. 3 the fluid reactor device mounted within a circulation

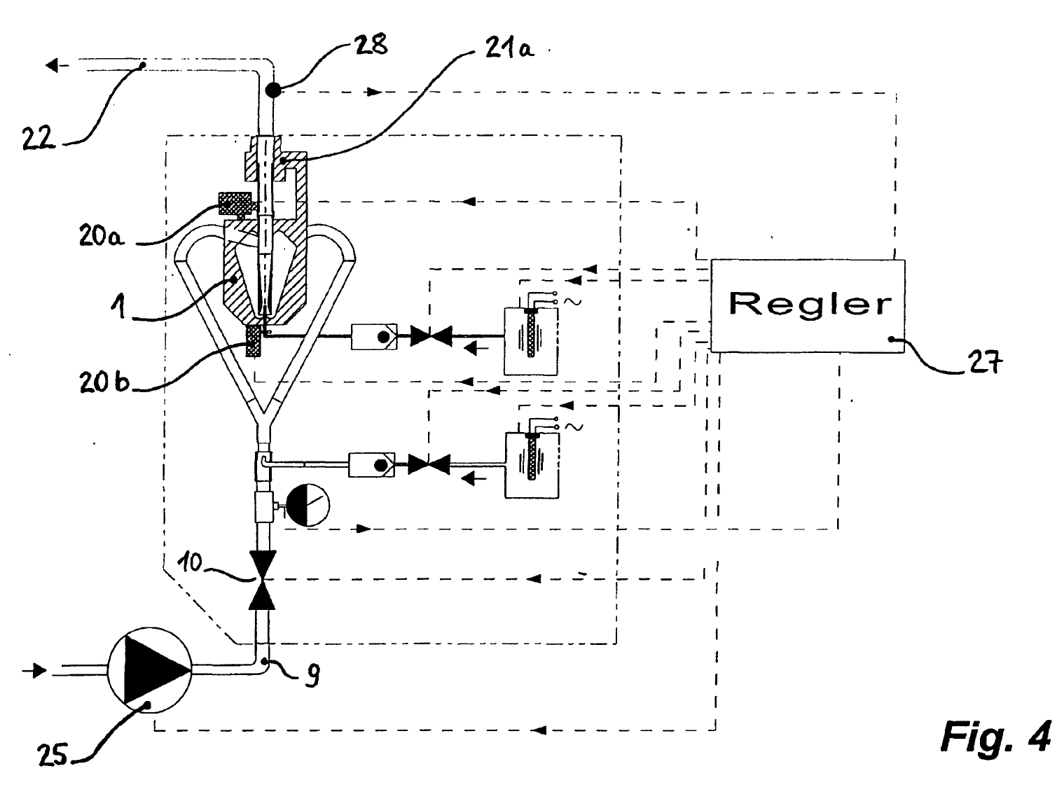

FIG. 4 the fluid reactor device with an integrated control.

FIG. 1 shows the principal configuration of the reaction chamber of the device according to the invention in cross-section (view B-B) and in longitudinal section (view A-A).

In a housing (1) a rotationally symmetrical cavity (2) is provided which in longitudinal section is heart-shaped and which serves as a reaction chamber. Connected to the housing (1) are: two media inlets (3), a media outlet pipe (4) for the medium to be treated, and an additive media inlet (5), and peripheral components such as hoses or pipes (6) for media transport.

The reaction chamber, the media inlets (3), and the media outlet pipe (4) are configured and correlated with one another such that in the fluid to be treated, when passing through the cavity (2) from the inlet opening to the outlet opening, a shearing strain as large as possible is generated by the friction of the individual flow layers with one another and with the wall of the cavity (2).

The reaction chamber, in the mounted position, is a cavity (2) of the housing that, with respect to the imaginary longitudinal axis, has rotational symmetry; the cavity has laterally in its upper part at least one media inlet (3) with an inlet opening that opens into the cavity (2). Expediently, the media inlet (3) is arranged such that the fluid to be treated enters the cavity (2) in the cross-section of the inlet opening tangentially to the peripheral surface of the cavity (2) and with descending flow direction.

The housing (1) is also provided in the upper part of the cavity (2) with a centrally arranged bore which is guided through the wall of the housing (1) preferably in the direction of the longitudinal axis of the cavity (2) and, in this way, coincides with it.

A media outlet pipe (4) is guided through this bore into the cavity (2) almost to the lower end thereof, wherein the media outlet pipe (4) is slidably supported in the bore so that the spacing between the opening of the media outlet pipe (4) and the lower end of the cavity (2) is adjustable.

In an advantageous configuration of the invention, the media outlet pipe (4) is embodied in the area near the opening as a Laval nozzle (7).

The contour of the cavity (2) in longitudinal section is similar to that of a heart.

The radius of the cross-section of the cavity (2) is enlarged first degressively along the longitudinal axis whose origin is imagined at the upper boundary of the cavity (2) until the tangent on the contour course of the longitudinal section of the cavity (2) extends parallel to this longitudinal axis. This point is reached at approximately 1/4 to ⅓ of the total length of the imaginary longitudinal axis of the cavity (2). The radius of the cross-section of the cavity (2) reaches its maximum value at this location.

From here, the radius of the cross-section is reduced initially progressively with increasing longitudinal coordinate to a longitudinal coordinate which is approximately 2/3 to ¾ of the total length of the longitudinal axis.

Subsequently, the radius of the cross-section of the cavity (2) decreases degressively, i.e., the contour course of the longitudinal section of the cavity (2) approaches asymptotically a line that is parallel to the imaginary longitudinal axis.

The end of the heart-shaped cavity (2) is formed by an arc-shaped contour which reverses the contour course, i.e., the contour of the cavity (2) now extends parallel to the imaginary longitudinal axis vertically upward in the direction of the bore. In the area of this contour reversal the cross-section of the cavity (2) has an inner radius and an outer radius. In this connection, the inner radius of the peripheral surface forms a pin (8) projecting from the bottom of the cavity into the cavity.

In the lower area of the housing (1) in the mounted position, an additive media inlet (5) having one or several openings that open at the end of the pin-shaped projection (8) into the cavity (2) is centrally arranged. For optimizing the pressure and flow conditions in the reaction chamber, the additive media inlet (5) is embodied, in analogy to the media outlet pipe (4), as a separate component which is connected to the housing (1) so as to be slidable relative to the housing in the direction of the imaginary longitudinal axis of the cavity (2).

Particularly advantageous for optimal results is the use of a catalytic coating in the reaction chamber and the Laval nozzle (7) as well as on other parts of the device which guide the media because, in this way, an accelerated course of the desired chemical reactions can be achieved.

FIG. 2 shows the principal configuration of the fluid reactor device according to the invention.

The medium to be treated is supplied to the reaction chamber by means of a main connecting line (9). For controlling the volume flow, a control valve (10) is arranged in the main connecting line (9). Downstream thereof, measured value pickups (11) are provided in the main connecting line (9) for obtaining process-relevant measured data such as pressure, temperature, volume flow, composition of the medium or chemical or/and biological loads. These measuring devices can be configured such that in addition to the visual measured value output on suitable output devices (12) the measured values can also be continuously or discontinuously made available for subsequent control or governing processes.

Downstream thereof, a feed device (13) is arranged for metering additive media such as, for example, air, oxygen, ozone, H₂O₂ which are made available as reaction components. The supply of the additive medium into the feed device (13) can be realized advantageously by an injection nozzle in such a way that by flow-technologically caused vacuum conditions in the main connecting line (9) the additive medium is automatically sucked in.

A blocking device or a check valve (14) is provided in the supply line of the additive medium in order to prevent undesired feed of the medium to be treated into the supply line. For manual or automatic metering of the additive medium in the supply line of the additive medium a fine control valve (15b) is also provided.

When the additive medium is a gas and an oxidation agent, for example, oxygen or air, the oxidation agent can be ionized or radicalized to e.g. ozone for improving the oxidation properties by means of a pretreatment device (16b) arranged upstream.

For increasing the volume flow of the additive medium past the amount provided by automatic intake, a compressor device (17) can be integrated into the supply line of the additive medium or can be arranged upstream of the pre-treatment device (16b).

Downstream of the feed device (13) the volume flow of the medium to be treated is divided into two or more partial volume streams which are supplied in separate inlet pipes (6) to the reaction chamber (2). In this connection, the use of flow dividers (18) is advantageous which, for optimizing the flow conditions and for reducing pressure losses, have a spread angle of less than 120°.

The inlet pipes (6) guide the medium to be treated to the housing (1) where it enters the media inlets (3). They flow tangentially to the cross-section of the cavity (2) with a flow direction slanted relative to the lower apex of the reaction chamber into the cavity (2). In this way, the medium to be treated is guided in a downwardly oriented helical line from the medium inlets (3) to the opening of the media outlet pipe (4).

Since the chemical reactions take place automatically as a result of the high-pressure in the hollow chamber (2) and since the media outlet pipe (4) with the typical cycloid suction vortex formation thus only provides the function of an after reaction and continuous process termination, the configuration of a high dynamic pressure in the hollow chamber (2) itself is required.

This is achieved by a corresponding selection of the available admission pressure of the medium to be treated in connection with the size of the media inlets (3) and of the media outlet pipe (4). It was found in this connection that a dynamic pressure of at least 2.5 bar is needed for performing a reaction with high-efficiency. This can be achieved, for example, in that the sum of the cross-sections of all media inlets (3) is selected to be twice as large as the smallest cross-sections of the media outlet (4).

The media outlet pipe (4) itself is configured in its lower area as a Laval nozzle (7) and projects axially adjustably into the cavity (2). In this connection, the media outlet pipe (4) is comprised of two or more parts connected with one another, wherein the visible upper part projecting outwardly from the housing (1) is a view pipe (19) made of transparent material and the lower part is configured as a Laval nozzle (7).

The axial adjustment of the media outlet pipe (4) is realized by means of a mechanical adjusting device. The media outlet pipe (4) is received in an axial bearing (21a) that is fixedly connected to the housing (1) or is secured relative thereto such that an axial adjustment during operation is possible without the position of the interface between the housing (1) and the pipeline of the main connecting line (9) being changed. In this way, an adjustment of the operating parameters is possible at any time according to the requirements and without great expenditure.

The media supply for the chemical after reaction in the media outlet pipe (4) can also be realized by pressure or advantageously by employing the vacuum in the Laval nozzle (7). In the same way as the media outlet pipe (4), the additive media inlet (5) is configured to be adjustable such that the position of the interface between the housing (1) and the pipeline of the outlet line remains unchanged when adjusting work is carried out.

In this connection, the adjusting mechanism of the lower additive media inlet (5) is designed such that an adjustment or readjustment to the optimal vacuum point into the media outlet pipe (4) is possible. For this purpose, the additive media inlet (5) is slidably supported in an axial bearing (21b) connected fixedly to the housing (1) or secured relative thereto. The adjustment can be carried out manually or by means of a control algorithm via an adjusting device.

The supply line of the additive medium is provided with a check valve (14) against undesired escape of the medium to be treated as well as with a fine control valve (15a) for manual or automatic metering of the additive medium. When the additive medium is gaseous and an oxidation medium, for example, oxygen or air, it can be ionized or converted to radicals such as ozone in a pre-treatment device (16a) arranged upstream.

FIG. 3 shows a preferred embodiment of the invention. Illustrated is the use of a fluid reactor device according to the invention in a media circulation with a separate storage container (23). The area which is enclosed by the dash-dotted line corresponds to the illustration of FIG. 2. For reasons of simplification, in this area of FIG. 3 not all components of the device are provided with reference numerals; in this respect, reference is being had to the corresponding information provided in FIG. 2.

In this connection, the nominal width of the main connecting line (9) is 25 mm. The control valve (10) is inserted for volume flow control. Downstream of the control valve (10), a pressure meter as a measured value pickup (11) is provided with integrated output device (12) and downstream thereof a feed device (13) in the form of an injector nozzle is also provided.

As a result of the vacuum in the main connecting line (9) the feed device (13) sucks in automatically an oxidation agents, in this case ambient air. For preventing backwashing of the medium to be treated into the vacuum line, the line is provided with a check valve (14). The adjustment of the volume flow of the oxidation agent is realized by means of a fine control valve (15b).

Expediently, ambient air is used as an oxidation agent which is processed by a controllable ionization device which serves as a pre-treatment device (16b). Downstream of the feed device (13), the volume flow is guided by a Y-member acting as a flow divider (18) and having a leg angle of the projecting legs of 45° in two identical partial streams. The supply into the reaction chamber is realized by means of two media inlets (3) which open tangentially into the cavity (2); they are displaced relative to one another by 180° and positioned at an angle of 15° relative to the longitudinal axis of the cavity (2) in a right-hand turning direction.

The greatest diameter of the cavity (2) is 136 mm. The smallest diameter of the cavity (2) is 64 mm. The outer diameter of the media outlet pipe (4) is 36 mm. Based on these dimensions, a cross-sectional ratio of 4,300 mm² to 700 mm² is provided, i.e., the greatest cross-section of the reaction chamber is more than six times greater than the smallest chamber cross-section. In this way, the required acceleration of the volume flow required for an effective reaction process is achieved in the cyclone that is being formed.

The media outlet pipe (4) is divided into three parts. In the lower area it is formed as an exchangeable Laval nozzle with the smallest diameter of 15 mm. The upper part is comprised of a transparent exchangeable plastic pipe of a nominal width of 25 mm. The center part has the same nominal width.

The entire media outlet pipe (4) is guided, on the one hand, slidably within the housing (1) and, on the other hand, also in an axial bearing (21a) with sealing action fixedly connected to the housing (1). For adjusting the media outlet pipe (4), the axial bearing (21a) is provided with an auxiliary device, in this case a hexagon having a standard wrench size.

At the upper end of the axial bearing (21a), a stationery fixed screw connection (24) is provided by means of which the device is connected with the pipeline system of the user.

At the lower end of the housing (1) an additive media inlet (5) is provided. This additive media inlet (5) is configured as an axially adjustable tube and projects through the wall of the housing (1) into the cavity (2) and from there into the Laval nozzle (7). For preventing backwashing, the supply line to the additive media inlet (5) is provided with a check valve (14). The adjustment of the volume flow of the oxidation medium is realized by means of a fine control valve (15a).

Expediently, ambient air is used also in this embodiment as an oxidation medium which can be processed by a controllable ionization unit which serves as a pre-treatment device (16b).

For achieving the required pressure, a volume flow pump (25) with a nominal pressure of 4 bar is used.

The entire device is installed in the system within in an independent circulation on a storage container (23) with free outflow (26), i.e., without counter pressure at the outlet side.

FIG. 4 shows a further preferred embodiment of the invention. The device according to the invention is supplemented by a control device (27) for the entire rejection process. The area surrounded by the dash-dotted line corresponds to the illustration of FIG. 2. For reasons of simplification, in this area of FIG. 4 not all components of the device are provided with reference numerals; reference is being had in this connection to the corresponding information in FIG. 2.

In the main connecting line (9) significant measured values such as volume flow, flows rate, temperature, pH value, redox value, the germ number, turbidity, and pressure of the medium to be treated as well as ionization rate and volume flow of the additive medium are continuously recorded. In the outlet line (22) of the device, data with respectto turbidity, media composition, redox value, and germ numberare recorded and continuously supplied to the control device (27).

Within the control device (27) which is configured as a cascade controller, the recorded measured data are processed by means of a computing algorithm based on the chemical principles and corresponding control parameters are then supplied to the external volume flow pump (25), the control valve (10), the fine control valve (15a) of the medium supply into the housing (1), the fine control valve (15b) of the medium supply into the main connecting line (9), the adjusting device (20a) of the media outlet pipe (4), the adjusting device (20b) of the additive media inlet (5), the pretreatment device (16a) of the additive media line to the housing (1), and the pre-treatment device (16b) of the additive media line to the main connecting line (9).

By using the control device (27), the dynamic pressure can be freely controlled or governed in accordance with the desired chemical reactions and reaction products according to a predetermined algorithm.

By means of measured value pickups (28) in the outlet line (22) of the device or on the media outlet pipe (4) or on a downstream storage container (23) or by means of feedback, the corresponding input parameters for a control action are determined. In the control processes the desired result of the reaction serves as the guiding parameter by means of a certain algorithm based on known chemical principles and characteristic device data or a comparison value which can be detected at the start of the control stretch.

With the aid of the following examples, the method according to the invention as well as the function of the device according to the invention will be explained in more detail.

### EXAMPLE 1

### Treatment of Lubricant Oil Emulsions

In machine construction and terotechnology as well as in metal manufacturing, cooling or lubricant oil emulsion and suspensions are used, frequently in open circulations. These are water/oil mixtures having an oil content of 2-3%. These lubricant oil emulsions serve, on the one hand, for cooling open bearings or, for example, for cooling and simultaneously lubricating when carrying out cuttings-producing operations such as the drilling or turning.

Such emulsions or suspensions form an excellent nutrient-containing substrate for germs, bacteria, and fungi so that, after a short period of time, they are attacked by decomposition processes and represent an extremely high odor load in the manufacturing facilities. In order to keep this load as low as possible, currently highly poisonous biocides are added to the emulsions in minimal amounts. As a result, a short-term reduction (generally only 3-5 days) of the load can be obtained leading to minimal satisfaction. A disadvantage is that the microorganisms fought in this way are simply killed off so that their remains collect within the circulation; this, in turn, provides a nutrient basis for other germs and bacteria and, in this way, decomposition processes result causing additional chemical loads in the emulsion. A disadvantage is also that the required frequent renewal and disposal of the emulsions cause a high operating expenditure.

By using the device according to the invention in an open circulation, the germ numbers in the emulsion were reduced from 6,500,000 CFU (colony forming units) in only two hours to 500,000 CFU, and the odor load as a result of the present organic compounds caused by decomposition processes dropped below the oder threshold. The killed-off germs cannot be detected even in the form of residual products in the emulsion. In addition, the lubricant efficiency was improved by 30%. The addition of biocides or other chemicals was no longer necessary. The service life of the emulsion could be improved by a factor 14.

The device was operated in open circulation. From the storage container of the lubricant oil emulsion, the lubricant oil emulsion was conveyed continuously by a pump with a conveying output of 10 m³/h and a pressure of 3.5 bar via a main supply diameter of 34 mm. As a result of the geometric conditions in the cavity and the media outlet pipe with its minimal diameter of 16 mm in the area of the Laval nozzle and in combination with the conveying output of the pump a corresponding dynamic pressure and reaction pressure is built up in the device. The high flow rate and rotational speed of the volume flow in the device of more than 60 revolutions per second effects a mechanical destruction of organisms that are present so that the reaction surface area of the organic compounds is increased. In connection with the oxygen of the air, additionally supplied and dissolved in water, the chemical oxidation process is initiated under pressure and accelerated in the cavity. In addition, by adding oxygen of the air in the media outlet pipe, the organic compounds contained in the already present vortex thread are oxidized. Downstream of the media outlet pipe, the treated water is returned into the storage container.

### EXAMPLE 2

### Drinking Water Degermination

Despite treatment of drinking water by the waterworks, at the consumer side germ and bacteria nests will form in the parts that guide the water; this can lead inter alia to loading of the drinking water with dangerous germs. A very dangerous type of germs and pathogens in the drinking water networks is Legionella Pneumophyla or generally Legionelle. In order to kill them off in the drinking water networks, technically extremely complex measures are required. For example, the water in the networks is heated for an extended period to temperatures above 45° C., in certain situations even up to 80° C., and maintained at this temperature. A different type of germ reduction uses technically complex devices with UV degermination. All prior art devices have in common that they require a technically great expenditure, exhibit partially minimal treatment efficiency relative to the water throughput, have a high risk for recontamination, and high operating and maintenance costs.

The use of the device according to the invention in a closed circuit results in a decomposition of the Legionelle from more than 110 CFU (colony forming units) to initially 7 CFU, permanently 0 CFU. Recontamination in the water networks can be permanently prevented by continuous or intermittent operation of the device. In addition to the reduction of the number of germs, such that they cannot even be detected as decomposed residues, a cleaning of the entire pipeline network takes place because of the change of viscosity such that other oxidizable foreign materials are decomposed and mineral deposits are flushed out as a result of the improved capillary properties of the water. Accordingly, a permanent renewal of the pipe and drinking water network occurs.

In the above described situation, the device was loaded by means of a bypass at the pressure side with the available network pressure of 4 bar. The throughput amount was 12 m³/h, the main inlet diameterwas 34 mm, and the smallest diameter in the media outlet pipe was 16.8 mm. In this way, the required high flow velocity and rotational speed in the cavity of up 70 revolutions per second for the mechanical comminution of the organic compounds and a sufficiently large reaction pressure for an accelerated decomposition of hydrocarbon compounds, in particular, protein compounds and amines, by a chemical cold oxidation with the oxygen of the air dissolved in the water were provided. By adding ionized oxygen of the air by means of an automatic suction effect into the vortex thread the last remaining germ residues were oxidized.

At the outlet side, the water was returned into the drinking water circulation by means of a pump arranged downstream of the device and provided for overcoming the network pressure present in the system. After completion of a basic cleaning process, a temporally intermittent operation of the device was sufficient for maintaining a stable germ-free state of the drinking water network.

### EXAMPLE 3

### Water Treatment in Industrial Washing Devices

In industry and trade, different types of washing devices are widely used. These are vehicle washing devices for trucks or rail car washing devices as well as machine or parts cleaning devices.

In order to provide in all of these devices the desired cleaning effect on the product, large amounts of cleaning agents are required which, inter alia, effect a reduction of surface tension or viscosity and employ it for the cleaning process. In addition to the required after treatment of the products by rinsing with clean water, these methods are cost-intensive with respect to maintenance and operation of the device as well as disposal of the waste products. The consumption of fresh water as a result of the limited cleaning action is very high in these methods. Moreover, in the case of multiple use of the wastewater as circulating water, extremely high germ loads by bacteria and fungi of partially more than 600,000 CFU (colony forming units) result which cause decomposition processes in the water and a resulting odor load of more than 2,500 OU (odor units).

In the past, this germ load was limited minimally by addition of different chemical or chemical-biological, usually highly poisonous, products in minimal dosage. A significant reduction of the cleaning agents was not possible because of the resulting reduction of the washing efficiency.

The use of the device according to the invention in an open circulation resulted in a reduction of the surface tension by more than 15%. Also, a reduction of the viscosity by more than 15% and thus significantly improved flow and wetting properties were observed. The germ load after operation for two hours dropped below 50,000 CFU and the odor load dropped below 7000 U.

An improvement of the washing efficiency was observed in that in connection with the use of completely desalinated water cleaning additives could be entirely eliminated in connection with a parts washing device.

As a result of the minimal water circulation quantity, a device with a maximum throughput of 5 m³/h was operated in open circulation. The wastewater was taken in by a pump from the storage container and supplied by means of the main inlet of a diameter of 25 mm to the device. By means of an injector, air was supplied to the reaction chamber in the inlet, wherein the oxygen contents of the air was radicalized in a corresponding device prior to its supply into the chamber. With the conveying pump pressure of 3 bar, the geometric conditions in the cavity, the inlet having a diameter of 25 mm, as well as the media outlet pipe which in the tapered area has a diameter of 9.8 mm and widens to 25 mm, the required reaction parameters are obtained. The water reaches a rotational speed of more than 80 revolutions per second in the cavity; the reaction pressure is more than 2 bar.

As a result of the high rotational forces, the resulting centrifugal forces, and friction, organic components were destroyed and oxidized immediately under the aforementioned reaction conditions by the oxygen radicals that are present. The reaction products are CO₂ and H₂O in the case of hydrocarbon compounds.

The high centrifugal forces as well as shearing forces in the system effect a change of the structure of the secondary valence bonds of the water in that the water molecules newly orient themselves leading to a change of the viscosity and of the surface tension. The surface tension was decreased by more than 15% from 0.073 N/m to 0.062 N/m.

Subsequent to the main reaction, air is supplied to the core of the vortex in the media outlet pipe for improving the after reaction. By under-running the vapor pressure downstream of the Laval nozzle in the media outlet pipe, a portion of the water goes into the vapor phase and mixes with the added oxygen from the air; this results in an improvement of the after reaction by oxidation in the gaseous vortex thread by more than 100%.

### EXAMPLE 4

### Pre-Treatment of Industrial Wastewater

Industrial wastewater cannot be compared to communal wastewater. In particular, the process-caused chemical waste products which increase the COD values (chemical oxygen demand) significantly, make it necessary to provide technically complex and expensive devices for lowering these values. The waste products contained in the wastewater include, inter alia, the entire range of organic chemical substances from chain compounds to ring compounds. Water loads frequently reach COD values of 500 up to more than 100,000 and cannot be supplied in a concentrated form in this magnitude to conventional biological water treatment plants.

The use of the device according to the invention caused within 3 hours a lowering of the COD value from 2,400 to less than 330 so that this industrial wastewater can be subjected to further treatment carried out by biological processes. A device with a treatment efficiency of 40 m³/h, a main inlet of 40 mm, and a media outlet pipe whose smallest diameter in the range of the Laval nozzle was 23 mm, were used. The conveying pressure provided by the pump was at 8 bar and the rotational speed of the fluid in the cavity was more than 110 revolutions per second.

This provided a sufficiently large reaction pressure for oxidation of aromatic compounds and esters. For accelerating and improving as well as initiating the oxidation process, air was added to the fluid in the inlet; prior to this, the oxygen contents of the air had been transformed to ozone radicals. In addition, a temperature increase of the fluid upstream and within the cavity was provided. A temperature increase by respectively 10 K doubled the reaction rate.

Based on these reaction conditions, chemical oxidation processes of the hydrocarbon compounds with the ozone present therein and atomic oxygen took place in the cavity. An after treatment of the fluid in the form of a continuation of the process of oxidation was carried out within the media outlet pipe in the vortex thread by additional supply of ozone. Beneficial for this process was the under-running of the vapor pressure of the fluid in the core of the vortex and its partial gaseous state caused by this. As a result of these reactions, CO₂ was primarily produced from these hydrocarbon compounds which was degassed downstream of the free outlet, as well as H₂O, and, in small amounts, salts that cannot be oxidized further, and residues of the hydrocarbons that are difficult to oxidize.

### EXAMPLE 5

### Pre-treatment of Communal Wastewater

Communal wastewater is processed in water treatment plants such that, in addition to the treated wastewater, a high amount of unusable sludge as a waste product is produced. This sludge must be thickened for disposal and subsequently transferred to landfills, to combustion in corresponding devices, or, in individual cases, moved onto agricultural lands for use as a fertilizer. Such methods are complex because of the high quantities of sludge and their composition which partially presents a great health hazard.

With the device according to the invention, such sludges which are comprised of individual flakes, were treated such that the organic components, up to 98%, were no longer visually detectable. The degree of digestion of the sludge is based on the oxygen consumption rate and provides a degree of digestion of the sludge flakes of more than 70% up to 98% after a two-hour treatment. After several treatments, the resulting BOD and COD values were lowered by more than 50% and reached environmentally compatible and permissible values in orderto reintroduce the water treated accordingly directly into nature.

The employed device was operated in open circulation, i.e., from the storage container the sludge water that could still be pumped was supplied to the device by means of a strong pump having an output of more than 4 bar and at a conveying volume of maximally 80 m³/h. Before reaching the cavity, ambient air was supplied to the volume flow, wherein the oxygen content of the air was radicalized to ozone or ionized by a corresponding pre-treatment.

With a nominal main inlet width and the selected geometric shape of the cavity of the device, a maximum rotational speed of more than 150 revolutions per seconds was achieved so that the sludge mixture was subjected to very high mechanical friction, and centrifugal force. This load destroyed mechanically the sludge flakes, bacteria, and germs, and increased their reaction surface area so that an accelerated oxidation occurred with the added oxygen from the air and ozone, primarily to form CO₂ and H₂O.

The reaction was carried out at ambient temperature and high pressure which results from the geometric conditions in the cavity and the nominal inlet widths. In the medium outlet pipe, which at the narrowest cross-section has a diameter of 24 mm and widens to 41 mm, additionally oxygen from the air, also pre-treated, was added to the core of the vortex so that an after reaction in the form of oxidation processes took place and, in this way, an improved efficiency of the device was obtained. Downstream of the medium outlet pipe the water treated in this way was returned pressureless to the storage container.

### EXAMPLE 6

### Pre-treatment of Fuels on the Basis of Vegetable Oils

Liquid fuels, in particular, vegetable oils such as rapeseed oil or sunflower seed oil, are not suitable for use in modern internal combustion engines in their original form. The reason for this are the chemical compounds which have a tendency to form resins as well as, in particular, the high viscosity which makes conveying to the internal combustion chamber almost impossible. Even conventional petroleum-based fuels must be pretreated in a sensible way.

In the processing of oils derived from plants, in particular, rapeseed oil, for use as fuel, the oils are mixed with thinning agents or liquefying agents such as methyl compounds for thinning and for binding of chemical compounds that are undesirable in the combustion process. These oils, treated in this way, can be used as fuel for diesel engines under certain conditions. A different liquefying action resides in that these fuels, upstream of the combustion chamber, are heated in order to lower the viscosity, i.e., they are made more flowable.

In contrast to known methods, the treatment of these vegetable oils with the device according to the invention provided a permanent viscosity change and thus liquefying action which also remained at temperatures under 0° C. In comparison to the starting product, the flow behavior was improved by approximately 50 to 70%. Organic chemical compounds, which resulted originally in thickening and resin deposits within the channels and supply lines, were no longer detected, i.e., the supply lines were free of incrustations even after prolonged operation. The calorific value of the vegetable oil treated in this way was not reduced relative to its original state. As a result of the improved viscosity, a significantly improved air/fuel mixing action was observed.

This was achieved by connecting the device in open circulation to a storage container for vegetable oils. The oil volume for reaching the desired viscosity was treated at least 20 times with the device. As a point of reference for the treatment, the treatment output of the device is defined as 20 m³/h.

The oil was supplied by means of a powerful pump of more than 6 bar by means of the main inlet with addition of ionized or radicalized oxygen from air into the cavity of the device. An additional temperature increase by at least 10 K improved the subsequent oxidation processes of undesirable chemical contaminants and increased the reaction rate by more than 100%. With the geometric conditions in the cavity, an inlet of 40 mm, and a media outlet pipe with a diameter narrowed within the Laval nozzle to 12 mm and widened at the outlet side to 28 mm, rotational speeds of the fluid within the cavity of more than 180 revolutions per second as well as a higher reaction pressure for the occurring oxidation processes are achieved. The resulting higher friction, shearing and centrifugal forces effect a new orientation of the molecular structure of the oil such that the viscosity and, accordingly, the flow behavior was improved permanently by at least 50%. Chemical organic foreign matter which, by inclusion in the molecular structure, can negatively effect them toward higher viscosity, are oxidized at the same time under the reaction conditions that are present primarily to CO₂ and H₂O. This oxidation process is continued and supplemented in the media outlet pipe in the vortex thread by adding air that has also been treated. At the outlet side, the treated oil is returned pressureless to the storage container.

### LIST OF REFERENCE NUMERALS

1 housing

2 cavity

3 media inlet

4 media outlet pipe

5 additive media inlet

6 inlet pipe

7 Laval nozzle

8 tubular pin

9 main connecting line

10 control valve

11 measured value pickup

12 output device

13 feed device

14 check valve

15a fine control valve of additive media inlet to the housing

15b fine control valve of additive media inlet to the main connecting line

16a pre-treatment device for additive media inlet to the housing

16b pre-treatment device to the main connecting line

17 compressor unit

18 flow divider

19 view pipe

20a adjusting device of media outlet pipe

20b adjusting device of additive media inlet

21a axial bearing of the media outlet pipe

21b axial bearing of the additive media inlet

22 outlet line

23 storage container

24 screw connection

25 volume flow pump

26 free outlet

27 control device

28 measured value pickup

1. A method for physicochemical treatment of fluid media, characterized in that at least two volume flows, or at least two partial volume flows generated by deflection of a volume flow, are moved at different speeds in the form of translational or/and rotational movement within one another or on one another with areal contact or surrounding one another in the same direction with different speed or opposite to one another as translational or/and rotational movement, wherein same speeds of the individual volume flows are permissible, for generating a friction based on the speed differential.

2. The method according to claim 1, characterized in that the volume flows are generated from one inlet by separation or are supplied as separate volume flows of different media.

3. The method according to claim 1 or 2, characterized in that the volume flows are forcedly guided in a pipe or container system surrounding the volume flows and in that the forced guiding action is configured such that at the same time rotational and translational movement of the volume flow is possible.

4. The method according to one of the claims 1 to 3, characterized in that the flow speed is selected such that, depending on the medium to be treated, flow-technologically a turbulent boundary layer is generated on each volume flow.

5. The method according to claim 4, characterized in that the flow speed is selected such that the boundary layers between the volume flows rub against one another and within one another by translational or/and rotational movement or within one another and in that the volume flows mix and swirl only in the boundary layer.

6. The method according to one of the claims 1 to 5, characterized in that the flow speed is selected such that for a rotational movement the resulting centrifugal force is so great that the secondary valence bonds of the molecules of the fluid medium are broken at least for a short period of time or/and long-chain molecules of organic or/and inorganic materials or/and microorganisms are mechanically destroyed or/and molecules of the medium or/and of the entrained materials are ionized or radicalized.

7. The method according to one of the claims 1 to 6, respectively, characterized in that the flow speed is selected such that for translational or/and rotational movement the resulting centrifugal force or/and translational force effects a geometric new orientation of the individual molecules as a result of their different atomic mass and thus their mass inertia.

8. The method according to one of the claims 1 to 7, respectively, characterized in that the volume flow or/and rotational speed are selected such that a material separation of the entrained materials or compounds and of the fluid medium is achieved in each individual volume flow.

9. The method according to one of the claims 1 to 8, respectively, characterized in that as a result of the new orientation of the molecular microstructure volatile foreign materials or gases are detached from this microstructure and released so that degassing takes place in the medium.

10. A device for physicochemical treatment of fluid media, comprised of a housing with a reaction chamber having rotational symmetry, one or several inlets connected to the reaction chamber, and an outlet pipe for the medium to be treated projecting into the reaction chamber and axially adjustable, an axially adjustable inlet for an additive medium, and peripheral components such as hoses or/and pipes for media transport, characterized in that the reaction chamber in longitudinal section is heart-shaped having a cross-section decreasing from the media inlet to the media outlet, wherein the smallest chamber wall radius located at the lower end of the reaction chamber is at most half the size of the greatest chamber wall radius and wherein the smallest cross-sectional area of the media outlet pipe is smaller than the total cross-sectional area of all media inlets.

11. The device according to claim 10, characterized in that the lower area of the outlet pipe projecting into the reaction chamber is configured as a Laval nozzle.

12. The device according to claim 10 or 11, characterized in that the smallest cross-sectional area of the media outlet pipe or of the Laval nozzle integrated therein is at most 0.7 times the size of the sum of the cross-sectional areas of the media supplies.

13. The device according to one of the claims 10 to 12, characterized in that the outlet pipe projecting into the reaction chamber is comprised of several parts, wherein the upper part projecting from the housing is a view pipe comprised of transparent material.

14. The device according to one of the claims 10 to 13, characterized in that the medium to be treated can be heated upstream of or in the chamber to a defined reaction temperature.

15. The device according to one of the claims 10 to 14, characterized in that the medium-guiding components of the device are coated with catalytically acting materials or are manufactured of catalytically acting materials.

16. The device according to one of the claims 10 to 15, characterized in that the media inlet or media inlets in the upper area of the reaction chamber open tangentially relative to the chamber wall, wherein their longitudinal axes are positioned relative to the symmetry axes of the reaction chamber at an angle of less than 90° and more than 45° so that the medium enters the reaction chamber in a descending entry direction.

17. The device according to one of the claims 10 to 16, characterized in that in the main connecting line a feed device is integrated with which the medium to be treated can be enriched with an additive medium before entering the reaction chamber.

18. The device according to one of the claims 10 to 17, characterized in that one or several pre-treatment devices are arranged peripherally such that the additive medium is ionized or/and transformed to a radical before being supplied.

19. The device according to one of the claims 10 to 18, characterized in that the media outlet pipe and the additive media inlet can be adjusted simply by hand by providing auxiliary devices such as blind bores, a knurled ring or wrench engaging portions.

20. The device according to one of the claims 10 to 19, characterized in that the media outlet pipe and the additive media inlet are adjustable in the axial direction and securable in their position by means of adjusting devices while the device is operating, wherein the interface between the housing and the peripheral line system remains stationary.

21. The device according to one of the claims 10 to 20, characterized in that the outlet pipe can be adjusted by a mechanical, electric, hydraulic or pneumatic adjusting device.

22. The device according to one of the claims 10 to 21, characterized in that, when using several media inlets, they are supplied from a main connecting line, wherein one or several flow dividers in a Y shape are used for dividing the volume flow, the flow dividers having legs at the outlet side positioned at an angle of less than 180° relative to one another.

23. The device according to one of the claims 10 to 22, characterized in that the inlet lines for additive media are secured by check valves against undesired entry of the medium to be treated.

24. The device according to claim 23, characterized in that the check valves have an opening pressure of less than 0.55 bar.

25. The device according to one of the claims 10 to 24, characterized in that the supply lines for the additive media are provided with control valves for metering the additive media.

26. The device according to one of the claims 10 to 25, characterized in that measuring devices are installed at the inlet or/and outlet side which record continuously or discontinuously process-relevant measured values and, as an analog or digital signal, make them available to a downstream evaluation devices or/and display them.

27. The device according to one of the claims 10 to 26, characterized in that the parameters determining the process are affected based on process-relevant measured values by means of a measuring, control, and governing device via corresponding actuators.
